(19) United States
(12) Patent Application Publication
(10) Pub. No.: US 2011/0208584 A1
(43) Pub. Date: Aug. 25, 2011

(54) METHOD, SYSTEM, AND APPARATUS FOR FACILITATING LOCAL RESOURCES OFFERINGS USING MOBILE DEVICES

(75) Inventors: Martin Peter Michael, Espoo (FI); Seamus Peter Moloney, Riihimaki (FI); Dhaval Joshi, Bangalore (IN)

(73) Assignee: NOKIA CORPORATION, Espoo (FI)

(21) Appl. No.: 13/125,958

(22) PCT Filed: Sep. 29, 2009
(86) PCT No.: PCT/FI2009/050774

§ 371 Date: Apr. 25, 2011

(30) Foreign Application Priority Data
Oct. 24, 2008 (IN) 2431/DEL/2008

(51) Int. Cl. G06Q 30/00

(52) U.S. Cl. 705/14.49

(57) ABSTRACT

Facilitating local resource offerings involves facilitating, via a mobile device, selection of a resource for local advertisement. The resource includes at least one of an offering and a request for an offering targeted to others in a local geographic area. A telephonic message is formed for presenting the local advertisement the telephonic message is communicated to the others in the local geographic area via a local telephonic architecture.

### FIELD OF THE INVENTION

This invention relates in general to computing, and more particularly to systems, apparatuses and methods for facilitating local resource offerings using mobile devices.

### BACKGROUND

Mobile phones are ubiquitous in developing countries. Most of the users in such countries are experiencing the power of Internet for the first time through mobile phones rather than through personal computers (PCs). Use of PCs in rural areas of developing countries is extremely low due to the relative high cost of such devices and lack of supporting infrastructure. Hence information activities like resource advertising and sharing are carried out using existing channels such as word of mouth and use of phone calls.

It is common in some countries to spend a large part of the day fetching goods. In order to make these activities more efficient, people in these countries have developed informal social practices in order help their neighbors and families in finding and buying the things that they will need. This type of social networking is very important in such countries for supporting day-to-day activities like shopping and the provision of other goods. Nonetheless, informal networks that rely on existing relationships and word of mouth are still less efficient than Internet technologies which offers access to vast amounts of data that allows people to find people and products quickly and in a very targeted fashion.

### SUMMARY

The present specification discloses a system, apparatus and method for facilitating local resource offerings using mobile devices. In one aspect, methods, apparatuses, and computer-readable medium facilitate, via a mobile device, selection of a resource for local advertisement. The resource comprises at least one of an offering and a request for an offering targeted to others in a local geographic area. A telephonic message for presenting the local advertisement is formed, and the telephonic message is communicated to the others in the local geographic area via a local telephonic architecture.

In more particular aspects, the telephonic message includes a short message service message. In such a case, communicating the telephonic messages to the others may involve sending the short message service message to a network server, which triggers matching the resources to resources submitted by the others in the local geographic area.

In other more particular aspects, communicating the telephonic message to the others comprises presenting the telephonic message as part of a call setup. In such a case, forming the telephonic message may involve setting a profile state of the mobile device, and communicating the telephonic message then may include communicating the telephonic message as caller identifier data during the call setup. In another case, the telephonic message may also or instead include an audio message, and communicating the telephonic message involves communicating the audio message as a customized ringback signal.

In other more particular aspects, the others in the local geographic area are selected by a user of the mobile device from contact data of the mobile device. In such a case, the selection may involve classifying the others in the local geographic area as one or both of a target for offers and a target for requests for offers.

In other more particular aspects, the resource includes a request for information communicated as a poll to the others in the local geographic area, in which case a result of the poll is distributed via the local telephonic architecture. Other aspects may involve downloading an executable object to the mobile device. In such a case, the executable object facilitates selection of the resource for the local advertisement, forming the telephonic message, and communicating the telephonic message.

In another aspect of the invention, methods, apparatuses, and computer-readable medium facilitate receiving, from mobile devices via a local telephonic architecture, telephonic messages from individuals in a local geographic area. From the telephonic messages, local advertisements for resources are determined. The resources include at least one of offerings and requests for offerings targeted to the local geographic area. The local advertisements are communicated to selected ones of the individuals.

In more particular aspects, the telephonic message includes a short message service message. In such a case, the selected ones of the individuals may be determined based on further comprising matching the resources to selected resources submitted by the selected ones of the individuals, where such selected resources include at least one of offerings and requests for offering targeted to the local geographic area.

In other more particular aspects, communicating the telephonic message to the selected ones of the individuals may instead or additionally include presenting the telephonic message as part of a call setup, such as caller identifier data and/or a customized ringback signal.

In other more particular aspects contact data from the individuals in the local geographic area is received from the mobile devices, and the selected ones of the individuals are determined based on the contact data. In such a case, the contacts may be classified as one or both of a target for offers and a target for requests for offers, and the classification may be used to determine the selected ones of the individuals.

In other more particular aspects, the resource includes a request for information communicated as a poll to the individuals in the local geographic area, the method further comprising distributing a result of the poll via the local telephonic architecture. Another aspect involves sending executable objects to the mobile devices. In such a case, the executable objects facilitate receiving the telephonic messages from the individuals in the local geographic area.

These and various other advantages and features of novelty which characterize the invention are pointed out with particularity in the claims annexed hereto and form a part hereof However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a block diagram illustrating an architecture according to example embodiments of the invention;

FIGS. 2-3 is are sequence diagrams illustrating local advertisement and resource matching according to an example embodiment of the invention;

FIG. 4A is a block diagram illustrating communicating local resources using an information voice system according to an example embodiment of the invention;

FIG. 4B is a flowchart illustrating the integration of resource advertisements into a contacts manager according to an example embodiment of the invention;

FIG. 5 is a block diagram illustrating a resource advertisement service used for gathering and disseminating information as a poll according to an example embodiment of the invention;

FIGS. 6A-6B are block diagrams illustrating the use of profile data and caller identifiers to advertise resources to an embodiment of the invention;

FIG. 7 is a block diagram of a user interfaces for designating offers and requests for offers according to an example embodiment of the invention;

FIG. 8 is a block diagram of a mobile user device according to an example embodiment of the invention;

FIGS. 9A and 9B are flowcharts illustrating procedures according to example embodiments of the invention; and

FIG. 10 is a block diagram showing a network service apparatus according to an example embodiment of the invention.

### DETAILED DESCRIPTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

The present disclosure is directed to methods, systems, and apparatuses that facilitate practical daily collaboration in localized activities such as shopping and finding local services. Such collaboration may be targeted for use by people in developing countries that may not have access to Internet infrastructures. Various disclosed embodiments facilitate the formation of social networks that allow an individual to help others out, and vice versa, via local telephonic infrastructures and mobile devices. For example, a local service may request information from those who join the service about products or services those individuals offer. Such a service may also allow the individual to list others known to the individual that also offer products and/or services. Such services can be, for example, the purchase of daily shopping goods or provision of daily labor. A network member may use a small application in their phone to indicate what they require and/or can provide regarding a particular item and/or service. This information can also be input without a specialized application, such as by voice and/or messaging to a local knowledge bank. This information may be passed to a server which calculates (in a privacy-sensitive manner) whether the item can obtained or provided to anyone in the social network of the member and assists in alerting of the item availability.

For users without access to PCs, belonging to existing online social networks and benefiting from some of their features may be difficult. Further, many Internet-based social networks are not designed for practical daily collaboration around local activities like going shopping for food or other items. Users without PCs may have access to cellular phones and similar mobile devices, although these devices are still primarily used for voice communications in developing countries. While such devices may have some data capabilities, those capabilities may not currently be used for maintaining and discovering social networks. Instead, mobile phones (and similar mobile devices) facilitate traditional social interactions by substituting for direct, person-to-person conversations. However, this type of direct person-to-person contact is not easily scalable to efficiently discover resources even in a small community. Further engaging in such person-to-person networking may compromise privacy, such as where a person want to take advantage of a good deal without alienating their current friends or relatives who may have similar offerings.

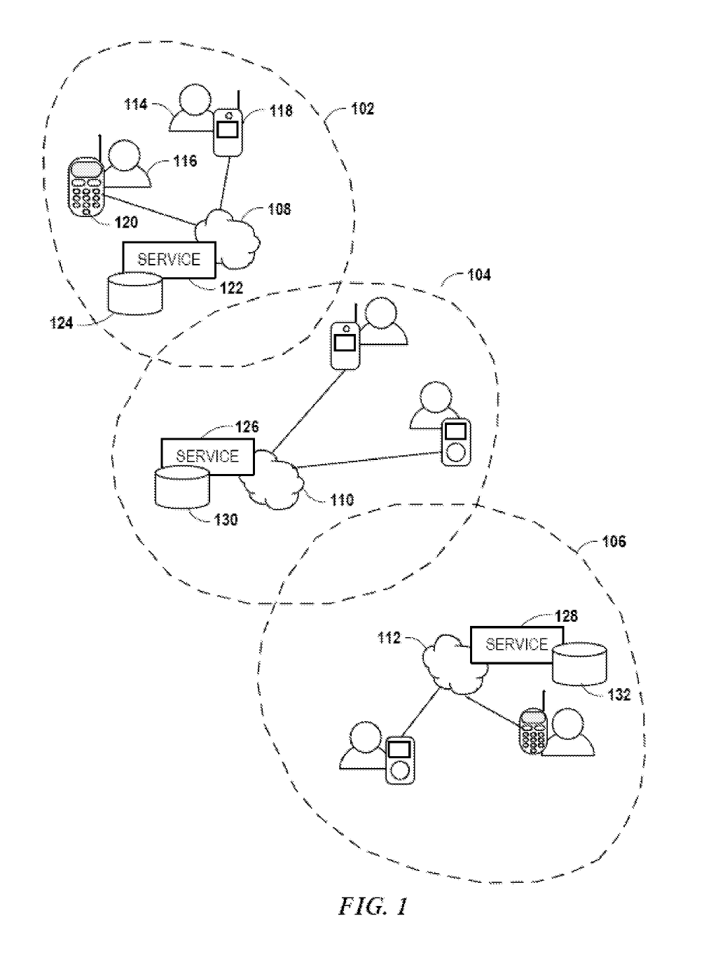

The present disclosure is directed to systems and apparatuses that facilitate the efficient advertisement and utilization of resources within a local community and/or local telecommunications architecture. In reference now to FIG. 1, a block diagram illustrates an architecture according to an embodiment of the invention. Generally, the architecture may utilize existing long range telecommunications infrastructure, including cellular phone and electronic messaging systems. Although such systems may offer access to the wider Internet, such Internet access may not always be needed for the purposes described herein. The architecture is intended to be useful in less developed (e.g., rural) locales where small communications devices may be the only practical means of communications. Due to their low cost, small size, battery operation, and ruggedness, such mobile devices are the computing device of choice (sometimes the only choice) in many developing parts of the world.

In communities that do not have extensive computing resources, finding and advertising products/services requires traditional techniques such as word of mouth, signs, community bulletin boards, local publishing (e.g., newspapers). In such communities, infrastructure such as roads, electrical power, landline communications, fuel, etc., may make both communication and travel difficult. Thus it is common that people in such communities may prefer to utilize locally available resources when at all possible. Although such communities can still receive products and services from outside a particular region, it may be assumed that there are price, social, and/or environmental benefits in consuming locally whenever possible.

In recognition of potential benefits of interacting locally, the block diagram of FIG. 1 demarcates a number of individual regions 102, 104, and 106. The illustrated regions 102, 104, 106 need not be geographically exclusive, as represented by overlaps between adjacent regions 102, 104, 106. The actual size of each region 102, 104, 106 may be dependent on local conditions, such population density, diversity of occupations and products locally available, condition of infrastructure, etc. For purpose of illustration, it may be assumed that each region 102, 104, 106 represents a geographic area within which any actor within the region would prefer to conduct business or otherwise interact.

Each of the regions 102, 104, 106 includes local data communications networks 108, 110, 112. These networks 108, 110, 112 may be part of a national or regional communications system (e.g., cellular phone network) and/or may be owned/maintained by smaller entities, including cities, neighborhoods, collectives, etc. Generally, any user within the regions 102, 104, 106 may be able to communicate locally (e.g., inter-regionally) via the networks 108, 110, 112, and the networks 108, 110, 112 may interact with each other, either collectively as a large network/internetwork, or in an ad-hoc fashion. However, because there may be greater interest in local products and services, large-scale connectivity may not be needed or desired in all cases, e.g., to facilitate purely local transactions.

Users in each region (e.g., users 114 and 116 in region 102) may have access to mobile devices (e.g., devices 118 and 120 associated with users 114 and 116) for performing transactions as described herein. Such devices 118, 120 may only need minimal data capabilities, such as access to voice and Short Messaging Service (SMS), although the system may provide enhanced features for users having advanced devices, e.g., mobile browsers, mobile email clients, etc. Generally, the devices 118, 120 interact via the local network 108 to enable the users 114, 116 to advertise and find products and services within the local region 102, and possibly in adjacent regions (e.g., region 104).

Generally, the network 108 facilitates access to a local service 122 that manages transactions with user devices 118, 120 and may process and store local data 124 derived from those devices 118, 120 and their users. The particulars of the transactions and data 124 will be described in greater detail below. Generally, each regional network 108, 110, 112 may have an associated service 122, 126, 128 and data store 124, 130, 132 to serve the local needs of users within the respective regions 102, 104, 106. The apparatuses that provide services 122, 126, 128 may be physically located at a single location, with each service 122, 126, 128 and data store 124, 130, 132 logically allocated to each respective region 102, 104, 106.

In other embodiments, apparatuses that provide services 122, 126, 128 and data stores 124, 130, 132 may be physically located within the respective regions 102, 104, 106. For example, apparatus that provide services 122, 126, 128 and data stores 124, 130, 132 may be co-located with a unit of the cellular infrastructure (e.g., base station controller for GSM cellular networks) that manages service for each region 102, 104, 106. Such an arrangement may be more robust (e.g., removes central point of failure) and might be able to rely on service apparatus of adjacent regions for service and data backup. Such a distributed system may also include features that alleviate privacy concerns. For example, if data describing transactions are maintained within a particular region (and possibly adjacent regions), it may prevent some or all of the data from being gathered by a remote nefarious actor and/or central authority acting outside the region.

The physical distribution of apparatuses that provides the services 122, 126, 128 may be taken a step further, such that no centralized apparatus idsfdsaasds needed, even with individual regions 102, 104, 106. In such an embodiment, the user devices 116, 118 themselves operate in a peer-to-peer fashion to maintain the service 122 and data 124 of the respective region 102. There may be challenges in implementing such a service (e.g., no guarantee of a serving device being powered on and available when desired), however future adoption of ever more advanced mobile devices may make such a peer-to-peer system feasible even in developing regions. Further, a hybrid system may be able to combine the best of centralized and peer-to-peer implementations. For example, peers 118, 120 may be able to gather and maintain transaction data locally, even where access to the network 108 is not available. When the network 108 is later available, the transaction data can be sent to the service 122 for synchronizing with and updating the local data store 124.

As previously mentioned, user apparatus (e.g., 118, 120) allow individuals to efficiently advertise and utilize locally available services with minimal reliance on Internet-type devices and infrastructure. Although in some embodiments, these devices 118, 120 may be able to provide these interactions as-is, in other cases the devices 118, 120 may be extended through the addition of software. For example, such technology as Java™ can be used to extend the functionality of devices 118, 120 via the network 108. Although embodiments described herein may refer to Java applications, in particular MIDlets, those of skill in the art will appreciate that this type of on-demand, platform-independent extension of device functionality is not limited to Java, and may include present and future technologies such as ActiveX™, F1ash™, .NET™, etc. It will further be appreciated that the description of the various components and their arrangement in FIG. 1 is presented for purposes of illustration, and the various transaction services can be implemented using other system configurations known in the art.

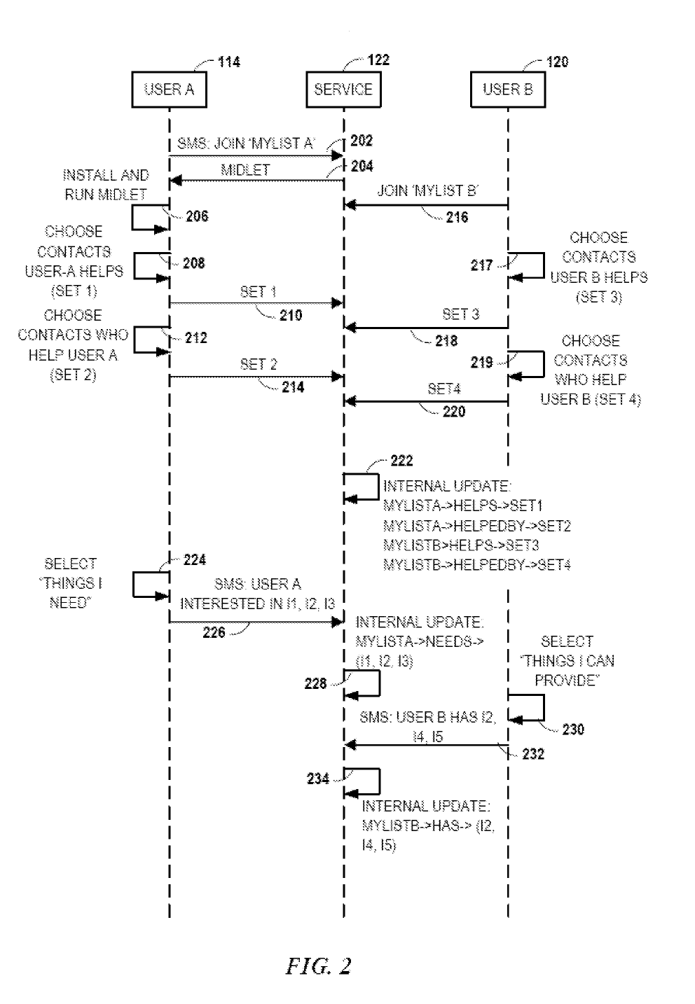

In reference now to FIGS. 2 and 3, a sequence diagram provides a specific example of how such systems may facilitate transactions according to an example embodiment of the invention. In particular, FIGS. 2 and 3 indicate a sequence of actions which may occur as the network is created (e.g., user registrations) and when the information is updated. The sequence diagrams in FIGS. 2-3 make reference to user devices 114, 120 and network service 122 that are analogous to those described in FIG. 1.

The illustrated implementation allows users to joining the system by, for example, sending an SMS to a service number and receiving back a link. This is represented by SMS message 202 sent from user device 114 to service 122. As part of the requesting SMS 202, the user specifies the name of the list they wish to use. This use of a list takes into account that there could be more than one person in the same family using the same device/list, so the list itself should not be tied to just the one mobile device 114, e.g., which may identified by its Mobile Subscriber Integrated Services Digital Network Number (MSISDN). The server records the list name (not shown) and makes a mapping that MYLISTA is in use by at least the MSISDN of device 114. Even with this mapping, the list may be independent of the MSISDN of device 114, so that a later access relative to the list from another device may be possible.

The service 122 may respond by sending a return SMS (not shown) with a link allowing download of an application. On clicking on the received link, a small application such as a Java Mobile Information Device Profile (MIDP) application (also referred to as a MIDlet) is downloaded 204 and installed 206 on to the device 114 of the user. This application can serve as the user's main interface to the service 122. The interface can be used, for example, to record the items they wish to offer or obtain. In one embodiment, the application may be configured as a shopping list used to indicate things that a user needs, e.g., purchase some fish. The application can be used by another person (e.g., a fisherman) to “publish” or advertise some quantity and type of fish for sale.

The first time that the application is run, the user may be asked a series of questions. The MIDlet may be configured to open a phonebook or contact manager on the device 114 using a personal information manager (PIM) application program interface (API) and loads the contacts. The user may be asked to indicate 208 which contacts to whom the user typically provides a service. This could be presented, for example, as a list of known contacts appearing with checkboxes beside them which the user could select. Different uses and embodiments may attach different meanings “provides a service to/for.” For example, the user might select neighbors and/or family members for whom they from time to time will pick up some extra goods at the store if they see a good offer (and receive payment from them later). It could also mean that a seller could list their regular customers by selecting them from these checkboxes. In this latter case, this could mean that the system would treat these selected people as the first that get informed when the seller has some new item for sale.

Data of selected 208 contacts (e.g., MSISDN, phone numbers. system user name) may be formatted as one or more SMS messages and sent 210 to the service 122, which records the set of “those helped” for user A. Similarly the user may also be asked to choose 212 contact data (e.g., MSISDN, phone numbers. system user name) of the people whom they are “helped by”. This could mean again the friends, family and neighbors who sometimes pick up something extra from the market for them, and/or the contacts of market sellers whom they often purchase things from and would like to get alerts from when they have goods they are interested in on sale. This second set of data is also sent 214 to the service 122, e.g., via SMS.

In FIG. 2, the same or similar sequence for registering user A may also be used for user B associated with device 120, as represented by actions 216-220. Note that user B may interact with device 120 using a MIDlet as shown for device 114, or some other different means. For example, the service 122 may provide a Wireless Application Protocol (WAP) Web page for a mobile browser that allows joining 216, and/or selecting 217, 219 contacts. In other embodiments, the interactions 216-220 may be performed via voice communications with a human operator or voice synthesis. In such a case, the service 122 may have access to contact lists, so that the user may be able to select or reject contacts via a telephone interface, e.g., speaking or touch tone selections.

At some point in time, both users will inform the service 122 of the set of contacts helped by the users (referred to in the figure as Sets 1 and 3) and those contacts the users help (referred to in the figure as Sets 2 and 4). This is reflected in internal state update 222 of the service 122. This state 222 includes a collection of individual registrants (represented by MYLISTx entries), “helps” or “helped by” relationship, and a list of contacts who are part of those relationships. The state 222 data of service 122 may exist after initial user registration, and this state 222 may be maintained/updated by users in similar fashion as shown for registration.

After registration, a second stage of service interaction involves identifying particular products or services that may be of interest to participants. In the second stage, both users A and B may begin to use the devices 114, 120 to record items which they either need or which they are able to provide to others. This could be facilitated, for example, by allowing user selection via drop down boxes under categories, typing the items in, using automatic voice or character recognition, and other user interface techniques known in the art.

In the illustrated example, user A selects 224 three items needed via device 114. This is communicated 226 to the service 122, which updates 228 its database. Similarly, user B selects 230 three things that user B can provide, and this is communicated 232 to the service 122 which performs an update 234. As can be seen from these interactions, user A needs item I2, and user B can provide I2. As a result, the service 122 will match up these users as shown in the continuation of the sequence in FIG. 3. In FIG. 3, additional transactions show an example embodiment of how the service 122 informs user A that user B has something to offer user A.

In response to any combination of inputs from users that causes an update to internal state, the service 122 may perform server-side matching 302. This example matching 302 is performed from the perspective of user B, who caused the last update (e.g., update 234 in FIG. 2), although other scenarios/perspectives may obtain a similar result. Generally, the server matches users who are linked by a “helps” and/or “helped by” relationship, and then looks at the offerings for those users in view of both the particulars of the offerings (e.g., type of product or service) and the correct relationship between offeror and offeree. Note that limiting the matching to explicitly defined contact relationships may be relaxed in some cases, such as where affected users agree to anonymous matching.

Generally, the server-side matching 302 may help to ensure that users A and B do not get a direct listing of the contacts and/or item lists held by other users. This helps ensure individual privacy, and also simplifies the amount and complexity of data exchanged between system devices 114, 120, and 122. Participating users should be able to check if there is matching for the specific items they are offering or requesting, and a preference should be given to those with an existing relationship. However, such users should be provided some assurance that such data is not viewable by others who have no such interest.

In the illustrated example, the service 122 has determined 304 that user A is a match to whom user B can provide I2. This availability is communicated 306 to user A, and an application of device 114 (e.g., previously downloaded MIDlet) can allow user A to accept this invitation by reserving 308 resource I2. This reservation is communicated 310 to the service (e.g., via SMS), and in response the service 122 communicates 312 the reservation to device 120 of user B. In response to an alert 314, user B sends a confirmation message 316 to the service 122. Thereafter, the users may complete the transaction 318 out of band, meaning they may call, text, and/or meet each other to exchange goods or services. It should be noted that the service 122 may provide other features to facilitate this transaction 318, such as automatically connecting the device 114, 120 (e.g., initiating voice call, preparing/sending text message, adding data to device contact database) upon both parties agreeing to the transaction.

Assuming the transaction is completed to each party's satisfaction, one or more of the users may signal as such. In this example, user A removes 320 item I2 from the list of things needed, and this is communicated 322 to the server 122, which performs an update 324. The server 122 may also perform an update 326 of user B's status regarding item 12, such as changing quantity of I2 in user B's inventory. Such a change 326 may or may not be needed for user B. For example, I2 could be a service where availability, not quantity, is the deciding factor of whether or not I2 can be offered. In other cases, such as where user B has a known quantity of item I2, the server 122 could perform a decrement of user B's count of item 12. However, if I2 is a service offered by user B, and the service 122 is able to limit availability of such services by date and/or time, then the update 326 may reflect this, similar to how a calendar application blocks out time for an appointment.

The messages communicated between devices 114, 120 and the server 112 may be standard formatted text messages using some predefined syntax that can be easily parsed and processed by the service 122. The devices 114, 120 may also perform similar parsing and processing, such as where the devices 114, 120 are using a specialized application (e.g., MIDlet) to process the transactions. In order to reduce data traffic, some embodiments may use a shorthand such as abbreviations codes for different items. The server 112 may be able to send updates of the new codes available to the devices 114, 120 from time to time to make a wider selection available to the users and to reduce the need for the devices 114, 120 to send the items as text. In other embodiment, richer content can be provided by the server 112, such as by using Multimedia Messaging Service (MMS) in place of SMS.

The example embodiments illustrate that existing mobile device architectures can be leveraged to ease the problem of collaborating with large social networks without requiring full Internet access. The use of a mobile phone in this way fits well with existing social behaviors. People already help each other in this way, but not in ways that are as efficient or scalable. Such embodiments are also a more efficient use of network resources (e.g., messaging and voice calls) than, for example, if a person had to call every contact and ask about need or availability of some item.

The service 122 can be made as simple or complex as needed to deal with synchronization issues. For example, if a requesting user is offered the same item by two “helpers,” the service may prioritize rank the offerings based on system-defined and user-defined criteria. For example, users could rate their own contacts (e.g., contacts 208, 212) based on performance factors (e.g., promptness, quality of product, ease of dealing), relationship (e.g., preference for family members), distance, cost, etc. In other cases, participants could pay an extra fee to the service to ensure that their offerings at least show up in response to queries, even if not highly ranked.

The local service 122 provides an opportunity for individuals and businesses to advertise their products and services in an efficient manner. Such a system can be made easy to use, particularly for individuals to whom phone and messaging paradigms are well understood, but who may be less comfortable with Internet usage, even if Internet access is available. A large portion of the processing can done on the server side, and thus the system can work even with low-end phones. Such a system can be inexpensive for end users, because most of the messaging can be accomplished via SMS. Only minimal Internet protocol traffic may be needed, such as downloading a MIDlet. There may also be alternatives to downloading MIDlets, such as provision of a MIDlet (or similar application) via Subscriber Identity Modules (SIM), proximity networking (e.g., Bluetooth), flash memory, and/or inclusion in manufactured phones.

In further example embodiments described below, a set of services can be augmented by an easy to use user interface (UI) and interaction styles tailored to users in developing countries. In these countries, particularly in rural areas, personal computer penetration and Internet access is low or nonexistent. Thus, as seen in FIG. 1, various regions (e.g., 102, 104, and 106) can maintain local knowledge banks (e.g., services 122, 126, 128 and repositories 124, 130, and 132) where contributors (users who add content to the bank) and info seekers (users who seek some form of information from the bank) use the local knowledge banks Such uses may include exchanging information about insights, techniques, know-how's, information about goods/products such as pesticides, fertilizers, labor availability, tools and resource availability, etc.

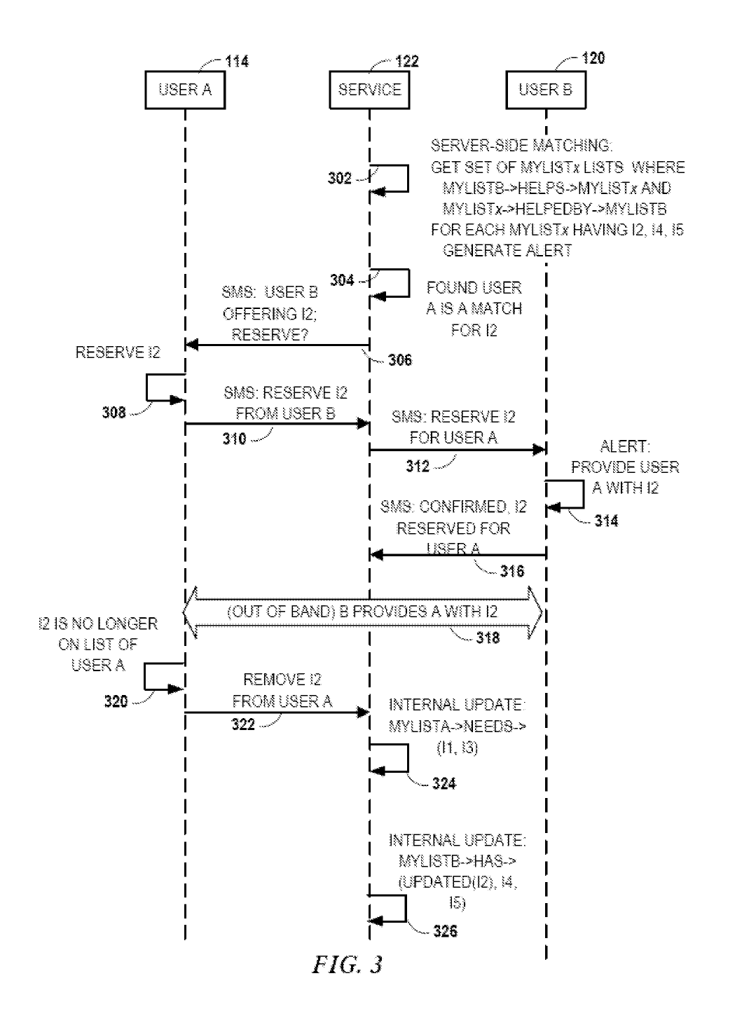

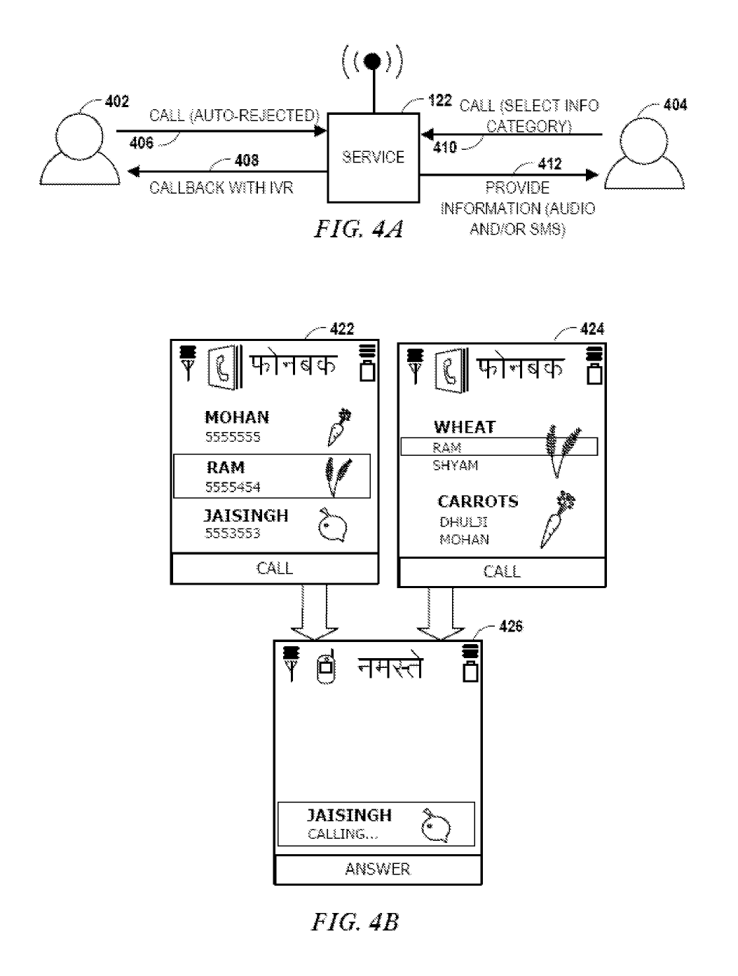

In reference now to FIG. 4A, a block diagram illustrates another example data exchange using a local knowledge bank according to an example embodiment of the invention. Generally, the knowledge bank is maintained via example service 122 described in previous figures. User 402 is a contributor and user 404 is an information seeker in this scenario. It may be assumed that the users 402, 404 use communication devices as previously described, such as cellular or landline telephones. In the example scenario of FIG. 4A, transactions utilize voice telephony, which may be better suited to languages that are difficult to compose in mobile devices and/or in cultures with strong oral traditions.

In FIG. 4A, contributor 402 is a user who wants to submit some piece of information to the knowledge bank via service 122. The contributor 402 calls 406 the local knowledge bank number. The service 122 auto rejects the call and after a few seconds, calls back 408 the same user. The call rejection 406 and ringback 408 may be beneficial for service plans where outgoing calls are billed to the user. In this case, user 402 is contributing to the knowledge bank, and therefore should not have to pay for the call charges.

As part of the ringback 408, the contributor 402 is taken through an interactive voice response in the local language understood by the user, 402. Interactive voice response (IVR) may include any telephony application that allows a computer to detect voice and/or touch tones during a normal phone call. An IVR system can respond with audio (either previously recorded or dynamically generated) to direct callers on how to proceed. In the illustrated example, the ringback with IVR 408 allows the user 402 to select the relevant category in which he or she wants to contribute. In other embodiments, a moderator (either human or machine) can help convert voice transactions into text, and carry on some interactions 406, 408 via SMS and similar technologies.

The information seeker 404 wants some form of information from the knowledge bank, and calls 410 the local knowledge bank via service 122. The user 404 navigates through the IVR to select a relevant category of information. In response, the service communicates the information 412 as audio and/or sends an SMS to the information seeker 404 so that the information can be utilized and/or saved for future use. As with the contributor 402, the interactions 410, 412 may be designed so that the service 122 calls back to avoid the information seeker 404 having to pay charges. In other variations, the seeker 404 may pay charges for the outgoing call 410, and in this way provide revenue to support the service 122.

The system shown in FIG. 4A may be used for any type of transactions as described herein, including initial registration with the service. Further, the call setup advertisement described in FIG. 4A may be combined with service messaging as described relative to FIGS. 2-3. For example, users who do not have an SMS-capable phone can still provide and receive information analogous to the data communicated via SMS by users A and B shown in FIGS. 2-3.

A knowledge bank maintained by the described service may include data regarding any type of product or service. In one example, the knowledge bank includes a crop cycle repository where users register themselves with the service with the type of crop they are currently cultivating. This can not only be used to advertise the crops and for needed products/services related to the crops (e.g., fertilizers, labor for harvest) but can also be used to provide up-to-date knowledge about the current conditions and techniques related to that crop. Farmers may describe what fertilizers are providing the best yields, what techniques are reducing losses due to pests, soil runoff, etc. This type of knowledge-based assistance according to an example embodiment is shown in the block diagram of FIG. 4B.

In FIG. 4B, example phonebook views 420, 422 are shown for a user who is registered to this service (e.g., as part of registration shown in FIGS. 2-3 and 4A). Via use of associated icons, the user gets to know the status of other farmers and what type of crops they are currently cultivating. Hence if a farmer wants to get the know-how of some specific crop that he plans to cultivate next year for example, the farmer may access contacts sorted by crop as seen in view 424. This association between contacts and products/services is a form of ambient information that can be maintained by the local service 122. These associations can be indicated by well known icons and be locally associated with contacts in device phone books. For example, in view 420 the association between crops and individuals is seen when looking at contact entries. In such a case, when a user receives a call from a contact in his phone book, the status (e.g., crop type) of the caller may be displayed with his or her name as seen in view 426.

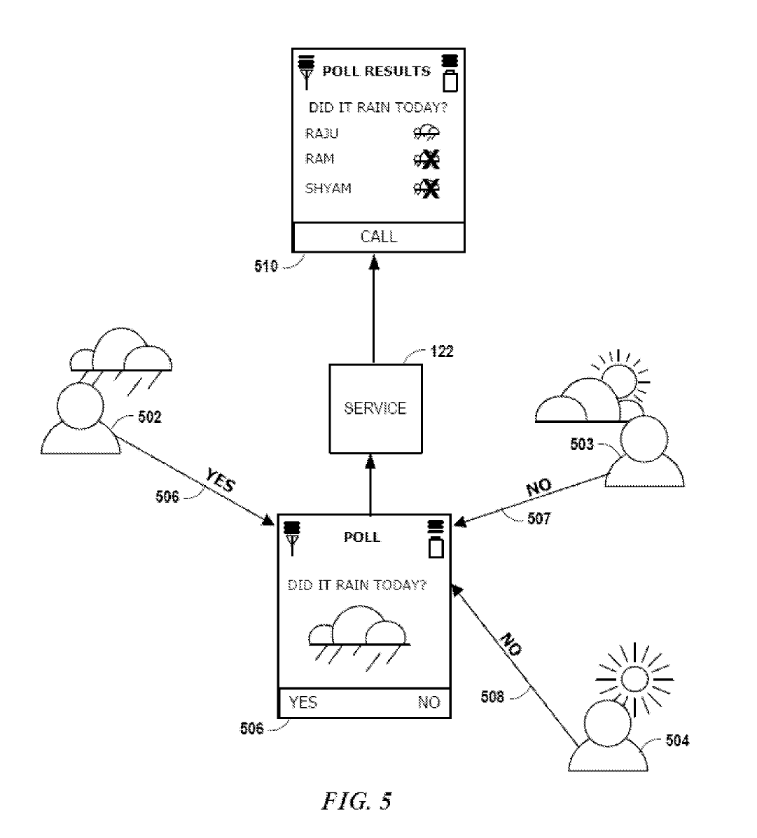

As previously described, the knowledge base maintained by the service such as 122 may contain other collective local knowledge besides products and services. In FIG. 5, a block diagram shows how this service can be extended to perform polling according to an example embodiment of the invention. The illustrated example is a graphic-based polling service which allows farmers to ask questions to his peers and receive answer in an easily comprehendible form. One or more users 502-504 may be registered with the service 122, such as described in relation to FIGS. 2-3 and 4A. One of the users 502-504 can select, via the service 122, a template to ask within the local social network about a specific question. The service 122 may provide a number of templates, and users 502-504 may also be able to create their own templates (e.g., via a downloadable application) and upload the templates to the service 122.

In this example, a user wants to find out about whether it rained or not, the user can select template 506 as a polling question to be sent to the social network of users 502-504. The users 502-504 may both receive the template 505 and respond 506-508 via a custom application, mobile Web page, IVR, text message exchanges, etc. The responses 506-508 in this example are YES or NO. The service 122 collects and collates the answers, and can display the results to the users 502-508 as seen in view 510.

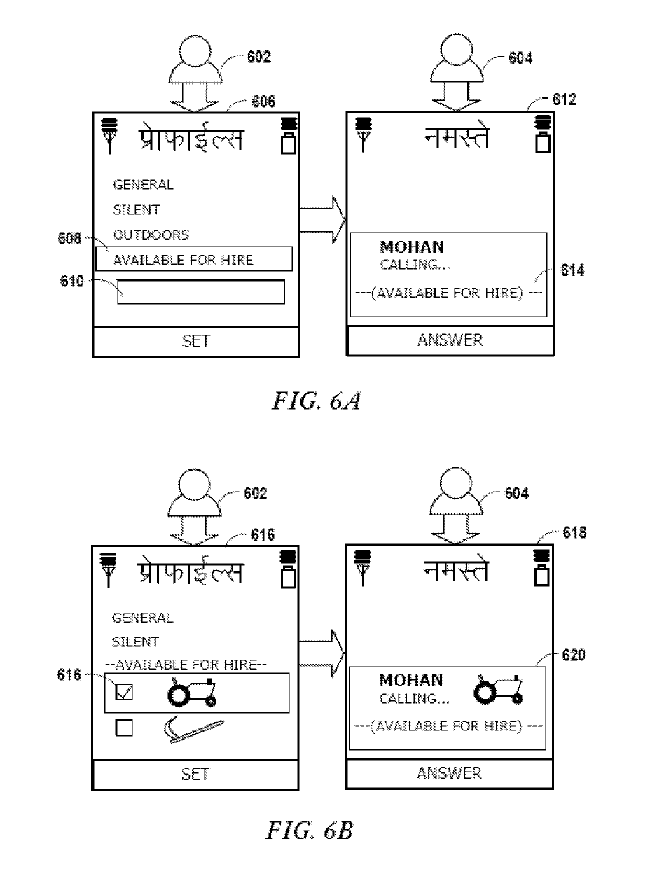

In reference now to FIGS. 6A and 6B, block diagrams illustrate the use of “profiles” to locally advertise/discover resources according to an example embodiment of the invention. Profiles are often used to change the behavior of the phone, such as controlling ring tones (silent, soft, loud). This is a widely known feature even in developing regions. In addition, some phones may also maintain a user “presence” that is commonly associated, for example, with text messaging applications. Presence generally indicates a users willingness and ability to communicate, and may take into account such factors as network availability, current phone profile, whether user is currently talking/messaging on the phone, etc. Such presence data can be communicated to others who might want to contact the user of a device before such contact is initiated.

These profiles and/or presence interactions can be used to advertise information about availability of some resource, or the need for such a resource. Once the user selects a profile, the respective status is broadcasted to all registered user. Whenever the profile selector calls or messages any other users, his status is communicated to them, e.g., via caller identity data sent as part of call setup and/or via presence data. In FIG. 6A, user 602 (Mohan) accesses a current profile via screen 606. One of those profiles is “Available for hire” 608, and may include a text entry box 610 to provide further details. When the user wants to advertise his availability for labor, the profile 608 is selected. When Mohan 602 calls user 604, the phone of user 604 shows screen 612 while waiting for user 604 to pick up. The screen 612 may include caller identity data that, as seen in portion 614, indicates the name of the callee 602 as well as the current profile/presence data. This portion 614 may also include text entered in box 610. Similar screen may also be communicated when user 604 calls Mohan 602 by using such technologies as presence awareness or custom ringback tones. In either event, the needed information may be communicated via the call attempt alone, and there may be no need to incur charges for a long phone conversation if the screen 612 (or other signaling) summarizes the basics of the possible transaction.

As was described, for example, in relation to FIGS. 2-3, a local service may collect common needs and capabilities in a common database. These needs/capabilities may also be represented by icons of conventional significance. Therefore, FIG. 6B shows a profile screen 616 that is populated with such icons. In this example, Mohan 602 may have a tractor is available for hire during the sowing season, and thus Mohan 602 can select icon 616 in his mobile device. When user 604 calls Mohan 602, the calling phone shows the icon in portion 620 of screen 618. The form and availability of these icons may be tailored to local needs and customs, and the users may be able to create their own icons (e.g., via downloadable MIDlet or similar application) and upload them to the local service (e.g., service 122 in FIG. 1).

Screens 612 and 618 are just a few examples of how availability (or needs) information can be communicated without even requiring users to answer a phone call. In other variations, such data can be disseminated via caller tunes or personalized ringback tones. When a caller makes a call, instead of the default telephone ringback tone, the caller hears relevant information from the service. This may occur whether or not the caller is registered for the service, but depending on the content of the customized ringback, may or may not require that the callee register for the service. An example where the caller might want to register without requiring the callee to register is where the caller is subscribed to the weather service. In such a case, when the caller makes an outgoing call, he/she gets latest information about weather service instead of a ringtone or a caller tune that is set by the receiver.

An example where the callee might want to register without requiring the caller to register is where the callee is offering some local service that may be of interest to the caller (e.g., “Mohan is available for hire; he has a tractor”). In such a case, customized selection of ringback tones may be performed using a service 122 that collects and matches needs and requirements as described in the example scenarios of FIGS. 2-3. Thus the customized ringback tone may only be played to callers determined through server-side matching, and others would hear the system default tone. This use of ringback tones, as well as the use of profiles and presence in caller identity data as shown in FIGS. 6A-6B, can be used together and in combination with the direct messaging communication of advertisements as described in relation to FIGS. 2-3, 4A-4B, and 5.

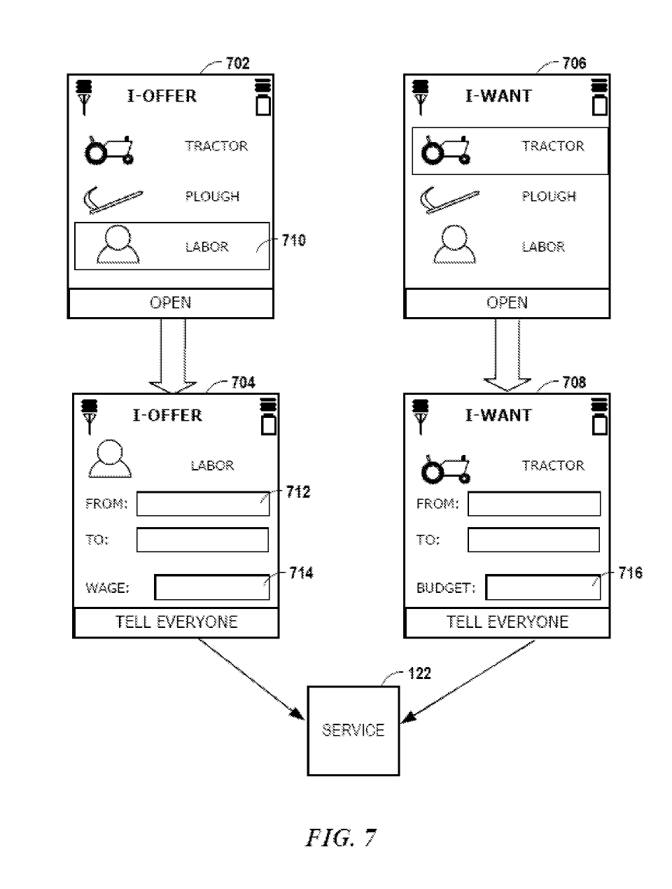

In reference now to FIG. 7, a block diagram illustrates user interfaces that may be used to facilitate placing and viewing classifieds according to example embodiments of the invention. The figure includes user interface screens 702, 704, 706, and 708 that may facilitate discovering and advertising services such as in the scenarios described in relation to FIGS. 2 and 3. In this example, the user may include farmers, traders and stakeholders that wish to discover locally available resources. The user interface may be visually oriented, keeping in mind problems such as illiteracy in developing countries. A user who wants to offer something can use the “I-Offer” screen 702. This screen allows selecting the relevant category, here labor 710, which causes the detailed description screen 704 to be displayed. Screen 704 allows the user input additional information (e.g., via boxes 712, 714) and submit it to the server. Although the screen 704 shows text input boxes other graphical components may be used, such as calendars (e.g., to select start date 712), sliders (e.g., to select ranges for wages 714), selectable icons, etc.

A farmer who is looking for hiring labor can use the “I-Want” mode 706 to see where labor is offered and then make contact with the respective persons who had offered the labor service. Screen 706 includes a list of items that the user may desire, and upon selecting a particular category, detail screen 708 is displayed. Screen 708 contains similar features as previously described screen 704. Submitting the data in screen 708 advertises the needs of the user via the local service. It will be appreciated that the “I-Want” and “I-Offer” are example user interface embodiments, and numerous variation in arrangement, labeling (e.g., language), user interface paradigm, user interface components, and the like, can vary without departing from the scope and spirit of the invention.

For example, the wage entry box 714 (and similar user interface component 716 in screen 708) can accept text inputs for an absolute value (e.g., $x.xx), a range (e.g., $x.xx-$y.yy) or be left open to the offeree (e.g., “bid” or “negotiable”). Similar selections may be facilitated by other user interface components, such as drop down boxes, sliders, checkboxes, etc. Where a price is not fixed, the infrastructure (e.g., the local knowledge bank service) may facilitate accepting and managing bids on behalf of users. For example, users can input ranges for prices and without directly revealing those ranges to the end users, matching may occur that provides an acceptable middle between both participants. In other embodiments, the system may facilitate direct negotiations between users, e.g., providing forms and tracking data relative to offers, counteroffers, acceptances, etc.

Even where a buyer or seller indicates a fixed price, the system may allow that price to be altered based on market conditions as determined by the local knowledge bank system. For example, a seller of a commodity such as fish, could set a fixed base price, and the system could automatically raise or lower that price by some amount depending on demand. The seller could set limits for how far and how fast that price might vary, and the system could automatically adjust the price and associated advertisements or offers based on activity surrounding the advertisement/offer.

As will be apparent from the described example embodiments, systems and apparatuses for local transactions are designed to facilitate all transactions via mobile devices. Such systems are designed to be easy to use for people without any prior PC and internet experience. For example, the techniques for collective advertising/discovery of resources use practices from existing user behaviors, such as direct messaging, managing missed calls, communication of caller data before call is connected, and use of profiles to communicate intent and information. Although some transactions may be amenable to peer-to-peer implementations, it is expected that some server platforms may be deployed to facilitate these information exchanges in developing regions. Such services may operate with or with central controls, and may operate on physically distributed apparatuses that each service a particular geographical region.

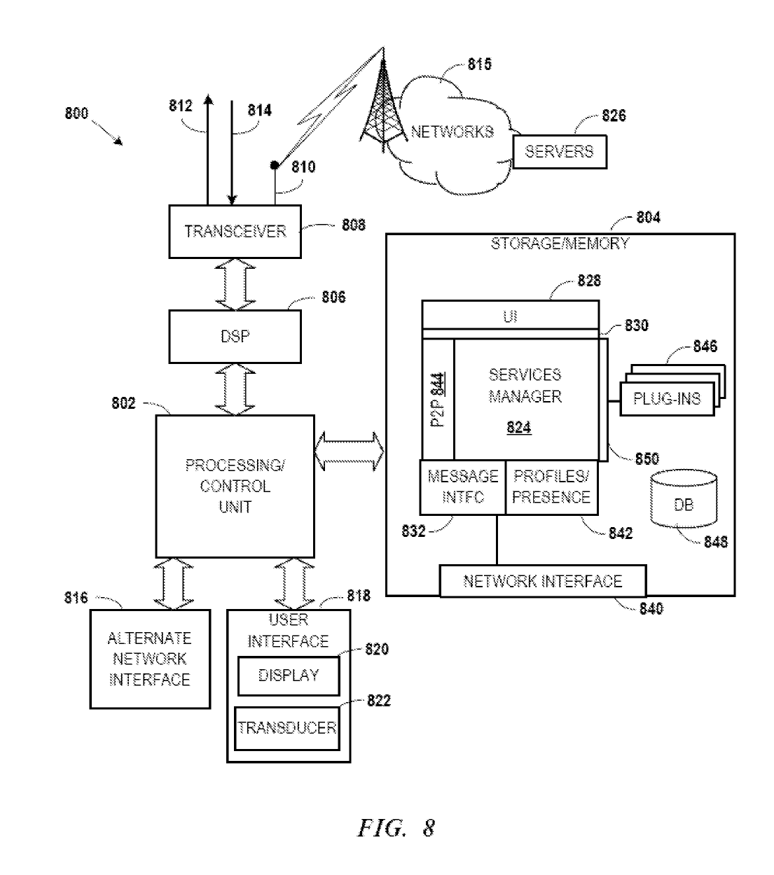

Many types of apparatuses may be as use devices to access services as described herein. User(s) in developing countries are increasingly utilizing mobile devices as their first and only computing devices, and therefore access of these services from such devices is desirable. In reference now to FIG. 8, an example is illustrated of a representative mobile computing arrangement 800 capable of carrying out operations in accordance with embodiments of the invention. Those skilled in the art will appreciate that the exemplary mobile computing arrangement 800 is merely representative of general functions that may be associated with such mobile devices, and also that landline computing systems similarly include computing circuitry to perform such operations.

The processing unit 802 controls the basic functions of the arrangement 800, and may include one or more specialized or general-purpose logic units for processing instructions. The instructions may be stored with the processing unit 802 and/or in a program storage/memory 804. In one embodiment of the invention, the program modules associated with the storage/memory 804 are stored in non-volatile electrically-erasable, programmable read-only memory (EEPROM), flash read-only memory (ROM), hard-drive, etc. so that the information is not lost upon power down of the mobile terminal. The relevant software for carrying out mobile terminal operations in accordance with the present invention may also provided to the storage/memory 804 by computer readable medium and/or computer program products. Such software may also be transmitted to the mobile computing arrangement 800 via data signals, such as being downloaded electronically via one or more networks, such as the Internet and intermediate wireless network(s).

The mobile computing arrangement 800 may include hardware and software components coupled to the processing/control unit 802 for performing network data exchanges. The mobile computing arrangement 800 may include multiple network interfaces for maintaining any combination of wired or wireless data connections. The illustrated mobile computing arrangement 800 includes wireless data transmission circuitry for performing network data exchanges. This wireless circuitry includes a digital signal processor (DSP) 806 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 808, generally coupled to an antenna 810, transmits the outgoing radio signals 812 and receives the incoming radio signals 814 associated with the wireless device. These components may enable the arrangement 800 to join in one or more networks 815, including mobile service provider networks, local networks, and public networks such as the Internet.

The mobile computing arrangement 800 may also include an alternate network/data interface 816 coupled to the processing/control unit 802. The alternate network/data interface 816 may include the ability to communicate via secondary data paths using any manner of data transmission medium, including wired and wireless mediums. Examples of alternate network/data interfaces 816 include USB, Bluetooth, Ethernet, 802.11 Wi-Fi, IRDA, Ultra Wide Band, WiBree, RFID, etc. These alternate interfaces 816 may also be capable of communicating via the networks 815, or via direct and/or peer-to-peer communications links.

The processor 802 is also coupled to user-interface hardware 818 associated with the mobile terminal. The user-interface 818 of the mobile terminal may include, for example, a display 820 such as a liquid crystal display and a transducer 822. The transducer 822 may include any input device capable of receiving user inputs. The transducer 822 may also include sensing devices capable of producing media, such as any combination of text, still pictures, video, sound, etc. Other user-interface hardware/software may be included in the interface 818, such as keypads, speakers, microphones, voice commands, switches, touch pad/screen, pointing devices, trackball, joystick, vibration generators, lights, etc. These and other user-interface components are coupled to the processor 802 as is known in the art.

The program storage/memory 804 typically includes operating systems for carrying out functions and applications associated with functions on the mobile computing arrangement 800. The program storage 804 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 804 of the mobile computing arrangement 800 may also include software modules for performing functions according to embodiments of the present invention.

The program storage/memory 804 in this example includes a service manager component 824 that manages interactions between one or more device users and a network service 826 that enables advertising and discovering local human services. The service manager 824 may include logic that facilitates user-side transactions such as illustrated in FIGS. 2-7. The service manager 824 may include a separate user interface 828 that can be localized and optimized based on the target user base. User interfaces 828 may include the capability to render any combination of the user interface features as shown in FIGS. 4-7. To facilitate variety of languages and cultures in which the apparatus may be used, multiple user interfaces 828 may operate with the service manager 824 via a generic application program interface (API) 830. Such an API 830 may also facilitate configuring displays for various levels of literacy, such as varying reliance on graphical icons and selectable widgets as opposed to text inputs/outputs.

On the network side, the service manager 824 may interact with the service 826 via a messaging interface 832. The messaging interface 832 may be extensible to use any messaging message means available via the network 815, such as SMS, MMS, voice telephony, email, instant messaging, etc. The messaging interface 832 may be a generic interface that separates the service manager 824 and a network interface 840. The network interface 840 may be a low-level system service that provides access to the interface hardware 806, 808, 816, and may include features such as protocol stacks, connection management, and other operating-system level network functions.

The service manager 824 may also be able to operate with a profiles/presence component 842 for indicating services and products offered and available as presence and call state. An example of integrating services manager 824 with presence/profile 842 is shown in FIGS. 6A-6B. In other examples of how this integration may be performed, the profiles/presence module 842 may be enabled to show persons as available (e.g., via direct connection request, chat room, instant messaging sessions, etc.) to each other only when there are matches for advertisements/requests as determined via services manager 824 and/or service 826.

Other enhancements to the services manager 824 are shown as peer-to-peer component 844 and plug-ins 846. The peer-to-peer component 844 may facilitate direct user-to-user transactions similar to those described as occurring between mobile devices and the service 826. For example, users may be able to maintain local databases 848 based on data collected in peer-to-peer transactions. The database 848 may include a full database that is replicated via Bittorrent-type distribution, or may include individual entries that are added via individual interactions. In other scenarios, the peer-to-peer module 844 may coordinate between peer-to-peer and service based transactions. For example, an individual may have a right-of-first-refusal agreement with user of device 800 pertaining to certain work, where the right-of-first refusal agreement is established outside of the service 826. When user of the device 800 makes a posting to the service 826, the peer-to-peer module 844 may first send the offer/request to the individual before posting to the service 826.

As described hereinabove, a services manager 824 may be used to coordinate and organize a wide variety of interactions in different social situations. As such, the needed functionalities may be tailored to fit a particular niche market. Because the target device 800 may have minimal storage and processing capabilities, it is preferable to have the manager 824 provide only the needed functionality. Thus the manager may utilize functional plug-ins 846 that can extend functionality via a plug-in interface 850. Specialized plug-ins 846 may include rules, templates, graphics, and other features that can tailor the experiences of the services manager 824 and user interface 828. For examples, plug-ins 846 may be available for specific trades or services (e.g., manual labor, skilled labor, domestic services), languages, locales, bidding rules/customs, local laws/rules/regulations, etc. The plug-ins 846 can be managed via the user interface 828 and be provided on demand from the service 826.

As described hereinabove, the functional components in the storage/memory 804 may be provided by way of dynamic provisioning of the device 800 via the network 815 and or local data interfaces. For example, the services manager 824 and other components may be downloaded to the device as a Java MIDlet or other executable module. The services manager 824 may establish and use the local database 848 for temporary storage, and/or for permanent replication of some or all of user-specific data accessible via the service 826. The user may be able access the local database 848 for other purposes, such as historical reference to previous interactions, billing/invoicing of products/services, updating/transferring contact data and transaction data to other devices and/or other users, etc.

The mobile computing arrangement 800 of FIG. 8 is provided as a representative example of a computing environment in which the principles of the present invention may be applied. From the description provided herein, those skilled in the art will appreciate that the present invention is equally applicable in a variety of other currently known and future mobile and landline computing environments. For example, desktop and server computing devices similarly include a processor, memory, a user interface, and data communication circuitry. Thus, the present invention is applicable in any known computing structure where data may be communicated via a network.

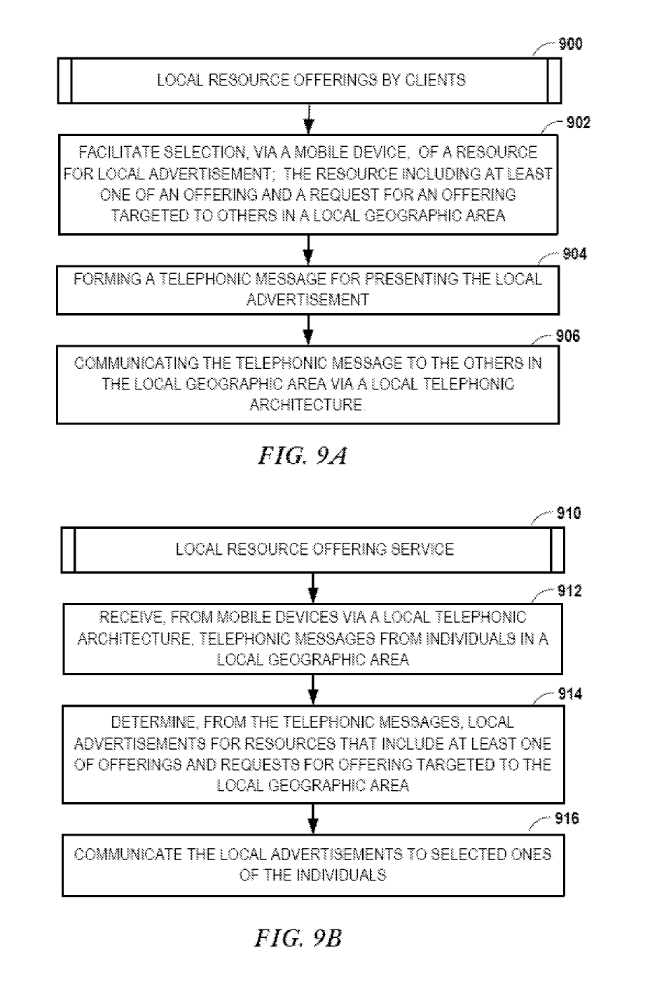

In reference now to FIGS. 9A and 9B, flowcharts illustrate clients and service procedures according to example embodiments of the invention. In FIG. 9A, a procedure 900 involves facilitating 902, via a mobile device, selection of a resource for local advertisement. The resource may include at least one of an offering and a request for an offering targeted to others in a local geographic area. A telephonic message is formed 904 for presenting the local advertisement, and the telephonic message is communicated 906 to the others in the local geographic area via a local telephonic architecture.

In FIG. 9B, a procedure 910 involves receiving 912, from mobile devices via a local telephonic architecture, telephonic messages from individuals in a local geographic area. From the telephonic messages, local advertisements for resources are determined 914. The resources include at least one of offerings and requests for offering targeted to the local geographic area. The local advertisements are communicated 916 to selected ones of the individuals.

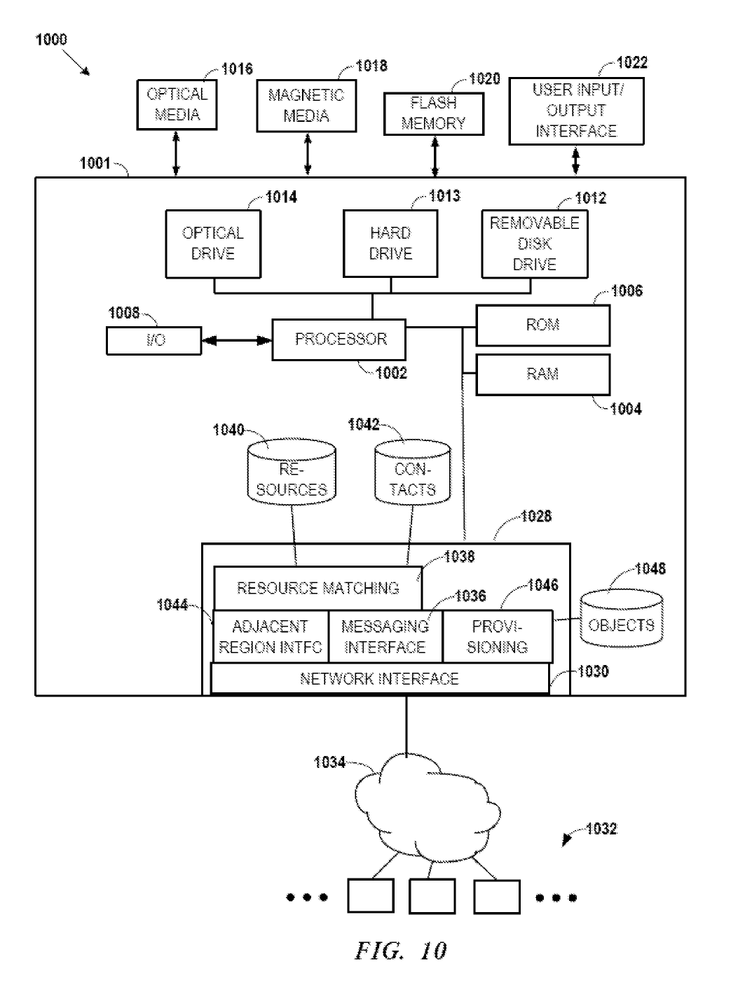

In reference now to FIG. 10, a block diagram provides details of a network service 1000 that facilitates resource matching according to example embodiments of the invention (e.g., analogous to various functions describe for service 122 hereinabove). The service 1000 may be implemented via one or more conventional computing arrangements 1001. The computing arrangement 1001 may include custom or general-purpose electronic components. The computing arrangement 1001 include one or more central processors (CPU) 1002 that may be coupled to random access memory (RAM) 1004 and/or read-only memory (ROM) 1006. The ROM 1006 may include various types of storage media, such as programmable ROM (PROM), erasable PROM (EPROM), etc. The processor 1002 may communicate with other internal and external components through input/output (I/O) circuitry 1008. The processor 1002 may include one or more processing cores, and may include a combination of general-purpose and special-purpose processors that reside in independent functional modules (e.g., chipsets). The processor 1002 carries out a variety of functions as is known in the art, as dictated by fixed logic, software instructions, and/or firmware instructions.

The computing arrangement 1001 may include one or more data storage devices, including removable disk drives 1012, hard drives 1013, optical drives 1014, and other hardware capable of reading and/or storing information. In one embodiment, software for carrying out the operations in accordance with the present invention may be stored and distributed on optical media 1016, magnetic media 1018, flash memory 1020, or other form of media capable of portably storing information. These storage media may be inserted into, and read by, devices such as the optical drive 1014, the removable disk drive 1012, I/O ports 1008 etc. The software may also be transmitted to computing arrangement 1001 via data signals, such as being downloaded electronically via networks, such as the Internet. The computing arrangement 1001 may be coupled to a user input/output interface 1022 for user interaction. The user input/output interface 1022 may include apparatus such as a mouse, keyboard, microphone, touch pad, touch screen, voice-recognition system, monitor, LED display, LCD display, etc.

The service 1000 is configured with software that may be stored on any combination of memory 1004 and persistent storage (e.g., hard drive 1013). Such software may be contained in fixed logic or read-only memory 1006, or placed in read-write memory 1004 via portable computer-readable storage media and computer program products, including media such as read-only-memory magnetic disks, optical media, flash memory devices, fixed logic, read-only memory, etc. The software may also placed in memory 1006 by way of data transmission links coupled to input-output busses 1008. Such data transmission links may include wired/wireless network interfaces, Universal Serial Bus (USB) interfaces, etc.

The software generally includes instructions 1028 that cause the processor 1002 to operate with other computer hardware to provide the service functions described herein. The instructions 1028 include a network interface 1030 that facilitates communication with mobile devices 1032 of a local telecommunicates infrastructure/network 1034. The network interface 1030 may include a combination of hardware and software components, including media access circuitry, drivers, programs, and protocol modules. The network interface 1030 may also include software modules for handling one or more network common network data transfer protocols, such as SMS, MMS, as well as voice and switching protocols associated with voice telephony (e.g., SS-7, GSM, CDMA, etc.).

The network interface 1030 may be a generic module that supports transfer of messages with the mobile devices 1032 via a messaging interface 1036. The messaging interface 1036 may provide the capability to form and parse various messages and other inputs, including text, graphics, touch-tones, voice, ringback tones, etc. A resource matching component 1038 utilizes the messaging interface 1036 to gather resource advertisements from users of the mobile devices 1032, perform matching on those advertisements, and communicate the messages back to the users. The resources communicated to the matching component 1038 may be stored in a resource database 1040. Resources of the database 1040 may be associated with contacts of a contacts database 1042. Each user of the system may have offerings and requests for offerings stored in the resource database 1040, as well as a listing of contacts in database 1042 to which the offerings/requests may be communicated. Each contact in the database may be associated with an “offer to” or “receive offer from” status used as part of resource matching by component 1038.

In some embodiments, the matching of resources may be limited to a region serviced by local infrastructure 1034. However, data from adjacent regions may also be desirable, such as when a user has contacts that are in two adjacent geographical regions. An adjacent region interface 1044 may be able to transfer resource matching data with an analogous service associated with another region (e.g., services 126 and 128 in FIG. 1).

The service 1000 may include the ability to provision particular mobile devices 1032 to interact with the messaging and resource matching modules 1036, 1038. For example, a provisioning module 1046 may distribute executable objects, plug-ins, message templates, profile templates, resource icons, etc. that are retrieved from a provisioning object database 1048. The objects 1048 may include platform-independent, executable modules such as Java MIDlets, scripts, etc.

For purposes of illustration, the operation of the service 1000 is described in terms of functional circuit/software modules that interact to provide particular results. Those skilled in the art will appreciate that other arrangements of functional modules are possible. Further, one skilled in the art can readily implement such described functionality, either at a modular level or as a whole, using knowledge generally known in the art. The computing structure 1001 is only a representative example of network infrastructure hardware that can be used to provide location-based services as described herein. Generally, the functions of the computing service 1000 can be distributed over a large number of processing and network elements, and can be integrated with other services, such as Web services, gateways, mobile communications messaging, etc. For example, some aspects of the service 1000 may be implemented in user devices via client-server interactions, peer-to-peer interactions, distributed computing, etc.

Any of the steps described or illustrated herein may be implemented using executable instructions in a general-purpose or special-purpose processor and stored on a computer-readable storage medium (e.g., disk, memory, or the like) to be executed by such a processor. References to ‘computer-readable storage medium’ and ‘computer’ should be understood to encompass specialized circuits such as field-programmable gate arrays, application-specific integrated circuits (ASICs), signal processing devices, computer program products, and other devices.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

1.-63. (canceled)

64. An apparatus comprising:
at least one processor; and
at least one memory including computer program code for one or more programs,
the at least one memory and the computer program code configured to, with the at least one processor, cause the apparatus to perform at least the following,
facilitate selection of a resource for an advertisement, wherein the resource comprises at least one of an offering and a request for an offering targeted to another user device in a geographic area;
cause, at least in part, forming of a message for presenting the advertisement; and
determine to communicate the message to the another user device.

65. An apparatus of claim 64, wherein the apparatus is further caused to:
send the message to a network server with instructions to match the resource to other resources submitted to the server by the another user device.

66. An apparatus of claim 64, wherein the apparatus is further caused to:
cause, at least in part, actions that result in presentation of the message to the another user device as part of a call setup.

67. An apparatus of claim 66, wherein the apparatus is further caused to:
communicate the message as caller identifier data during the call setup.

68. An apparatus of claim 64, wherein the apparatus is further caused to:
set a profile state of the apparatus as part of forming the message.

69. An apparatus of claim 64, wherein the another user device is selected by a user of the apparatus from contact data of the apparatus.

70. An apparatus of claim 64, wherein the apparatus is further configured to:
classify the another user device as one or both of a target for offers and a target for requests for offers.

71. An apparatus of claim 64, wherein the message comprises a short messaging service message.

72. An apparatus comprising:
at least one processor; and
at least one memory including computer program code for one or more programs,
the at least one memory and the computer program code configured to, with the at least one processor, cause the apparatus to perform at least the following,
receive one or more messages from one or more users associated with one or more user devices in a geographic area ;
determine, from the one or more messages, selection of one or more advertisements for resources that comprise at least one of offering and request for offering targeted to the geographic area; and
determine to communicate the one or more advertisements to one or more selected users associated with the one or more user devices.

73. An apparatus of claim 72, wherein the selected ones of the users are determined based on matching the resources to selected resources submitted by the one or more selected users, wherein the selected resources comprise at least one of offering and request for offering targeted to the geographic area.

74. An apparatus of claim 72, wherein the apparatus if further caused to:
communicate the advertisements as part of a call setup.

75. An apparatus of claim 74, wherein the apparatus is further caused to:
communicate the advertisements as caller identifier data during the call setup.

76. An apparatus of claim 72, wherein the apparatus is further caused to:
receive contact data from the user devices; and
determine the one or more selected users based on the contact data.

77. An apparatus of claim 76, wherein the apparatus is further caused to:
classify the contact data as one or both of a target for offer and a target for requests for offers; and
determine the one or more users based on the classification.

78. An apparatus claim 72 wherein the apparatus is further caused to:
cause, at least in part, actions that result in sending executable objects to the user devices,
wherein the executable objects facilitate receiving the advertisements.

79. A method, comprising:
facilitating selection of a resource for an advertisement, wherein the resource comprises at least one of an offering and a request for an offering targeted to another user device in a geographic area;
causing, at least in part, forming of a message for presenting the advertisement and
determining to communicate the message to the another user device

80. A method of claim 79, further comprising:
sending the message to a network server, with instructions to match the resource to other resources submitted to the server by the another user device.

81. A method of claim 79, further comprising:
causing, at least in part, actions that result in presentation of the message to the another user device as part of a call setup.

82. A method of claim 81, further comprising:
determining to communicate the message as caller identifier data during the call setup.

83. A method of claim 79, further comprising:
determining to set a profile state of the apparatus as part of forming the message.

84. A method of claim 79, wherein the another user device is selected by a user of the apparatus from contact data of the apparatus.

85. A method of claim 79, further comprising:
classifying the another user device as one or both of a target for offers and a target for requests for offers.

86. A method of claim 79, wherein the message comprises a short messaging service message.

87. A method comprising:
receiving one or more messages from one or more users associated with one or more user devices in a geographic area
determining, from the one or more messages, one or more advertisements for resources that comprise at least one of offering and request for offering targeted to the geographic area; and
communicating the one or more advertisements to one or more selected users associated with the one or more user devices.

88. A method of claim 87, wherein the one or more selected user are determined based on matching the resources to selected resources submitted by the one or more selected users, wherein the selected resources comprise at least one of offerings and requests for offering targeted to the geographic area.

89. A method of claim 87, further comprising:
communicating the advertisements as part of a call setup.

90. A method of claim 89, further comprising:
communicating the advertisements as caller identifier data during the call setup.

91. A method of claim 87, further comprising:
receiving one or more contact data from the user devices; and
determining the one or more selected users based on the contact data.

92. A method of claim 91, further comprising:
classifying the contact data as one or both of a target for offers and a target for requests for offers; and
determining the one or more selected user based on the classification.

93. A method of claim 87, further comprising:
causing, at least in part, actions that result in sending executable objects to the user devices,
wherein the executable objects facilitate receiving the one or more advertisements.
